(19) United States
(12) Patent Application Publication
(10) Pub. No.: US 2013/0017425 A1
(43) Pub. Date: Jan. 17, 2013

(54) Storage Battery Cell, Assembled Battery, Assembled Battery Setup Method, Electrode Group, and Production Method of Electrode Group

(71) Applicants: Erika WATANABE, Mito-shi (JP); Shigenori Togashi, Abiko-shi (JP)

(72) Inventors: Erika WATANABE, Mito-shi (JP); Shigenori Togashi, Abiko-shi (JP)

(73) Assignee: Hitachi, Ltd., Tokyo (JP)

(21) Appl. No.: 13/545,088

(22) Filed: Jul. 10, 2012

(30) Foreign Application Priority Data
Jul. 11, 2011 (JP) 2011-152989

(51) Int. Cl. H01M 2/02; H01M 4/139; H01M 4/64; H01M 4/00; H01M 2/10

(52) U.S. Cl. 429/94; 429/163; 429/99; 429/211; 29/623.5

(57) ABSTRACT

A storage battery cell includes: an electrode group in which a positive electrode including positive electrode current collector foil provided with a positive electrode layer containing a positive electrode active material, a negative electrode including negative electrode current collector foil provided with a negative electrode layer containing a negative electrode active material, and a separator that intervenes between the positive electrode and the negative electrode are laminated; a battery cell container; and an electrolyte, wherein: the positive electrode active material and the negative electrode active material respectively are substantially uniformly distributed, and the positive electrode layer and the negative electrode layer are provided respectively with regions in which respective quotients of the positive active material and the negative active material in the electrolyte are varied.

### INCORPORATION BY REFERENCE

The disclosure of the following priority application is herein incorporated by reference: Japanese Patent Application No. 2011-152989 filed on Jul. 11, 2011.

### BACKGROUND OF THE INVENTION

1. Field of the Invention

The present invention relates to a technology in the field of storage battery cell such as lithium ion secondary battery cell.

2. Description of Related Art

In recent years, it has been demanded to promote energy saving accounted for national movement for saving resources such as fossil fuels and for preventing global warming. Under the circumstances, among secondary battery cells, a lithium ion battery cell with a large capacity and a small size is expected as an important electric storage device for realizing an energy saving society. To this end, demand is being expanded centered on consumer applications for power sources for mobile information terminals and cordless electric devices, industrial applications such as power sources for electric power tools, and in-vehicle applications for electric vehicles and hybrid electric vehicles. Furthermore, development of a battery cell having high performance such as high output power, high energy density depending on various applications is being accelerated. A high output battery cell tends to generate heat due to Joule heat upon discharging large current, and the high energy density batteries accumulate heat after long time use. Due to a difference in heat dissipation performance in the inside of the battery cell and a difference in current density in the periphery of electrode tabs, the distribution of temperature in the inside of the battery cell becomes non-uniform.

When temperature distributes non-uniformly in the inside of a battery cell, the following problems will arise:

1) Power density decreases at high temperature region.
2) The temperature increases further due to an increase in resistance of the current collector foil at the high temperature region and this causes contact failure between the electrode active materials due to a local expansion of the current collector foil.
3) Migration of lithium ions is hindered due to partial decomposition/evaporation of the electrolyte.
4) Non-uniform distribution of temperature causes problems such as local cycle deterioration and internal short-circuit, which eventually results in a shorter working life of a battery cell as a whole.

As a background art for decreasing the temperature distribution in the inside of a battery cell, an electrode for a power storing apparatus is disclosed in Japanese Patent Laid-Open Publication No. 2008-53088. The electrode disclosed in this patent literature includes “a current collector foil and a plurality of electrode patterns formed on a surface of the current collector foil, and among the plurality of electrodes, a density of electrode patterns in a region where heat is radiated less than in other region, has a lower formation density of the electrode patterns than that in the other region”. Japanese Patent Laid-Open Publication No. 2008-78109 discloses an electrode for an electric storage device, in which “the structure of the electrode layer varies according to the position in the electrode layer such that a current density in a region of the electrode, where heat dissipation performance is lower than in other region of the electrode, is lower than the current density in the other region of the electrode”. Japanese Patent Laid-Open Publication No. 2008-53088 and Japanese Patent Laid-Open Publication No. 2008-78109 relate to a technology according to which active material is provided such that the density of active material mounted on the current collector foil is distributed depending on the position on the current collector foil.

### SUMMARY OF THE INVENTION

In the electrode for a power storing apparatus disclosed in Japanese Patent Laid-Open Publication No. 2008-53088, since there are formed a portion of the current collector foil that is coated with the active material and a portion that is not coated with the active material, the electrode area becomes small. Since current does not flow in a portion where no electrode is formed, it may results in a decrease of power density.

On the other hand, the electrode for secondary battery cells disclosed in Japanese Patent Laid-Open Publication No. 2008-78109 is constructed such that the portion of the current collector having low heat dissipation performance is coated with a decreased amount of the active material to reduce the thickness of the active material. However, the decreased amount of the active material causes a decrease in power density of a battery cell as a whole.

According to the 1st aspect of the present invention, a storage battery cell comprises: an electrode group in which a positive electrode including positive electrode current collector foil provided with a positive electrode layer containing a positive electrode active material, a negative electrode including negative electrode current collector foil provided with a negative electrode layer containing a negative electrode active material, and a separator that intervenes between the positive electrode and the negative electrode are laminated; a battery cell container that houses the electrode group; and an electrolyte injected in the battery cell container, wherein: the positive electrode active material and the negative electrode active material substantially uniformly distribute in the positive electrode layer and the negative electrode layer, respectively, and the positive electrode layer and the negative electrode layer in which the positive electrode active material and the negative electrode active material, respectively, distribute substantially uniformly, are provided respectively with regions in which respective quotients of the positive active material and the negative active material in the electrolyte are varied.

According to the 2nd aspect of the present invention, in a storage battery cell according to the 1st aspect, it is preferred that the respective quotients of the positive electrode active material and the negative electrode active material in the electrolyte are controlled depending on respective thicknesses of the positive electrode layer and the negative electrode layer, and each of the positive electrode layer and the negative electrode layer has regions where the respective thicknesses of the positive electrode layer and the negative electrode layer are varied in a plane of the electrode group.

According to the 3rd aspect of the present invention, in a storage battery cell according to the 2nd aspect, it is preferred that the electrode group is a laminate-type electrode group in which a positive electrode, a negative electrode and a separator, which respectively are shaped as rectangular sheets, are laminated, and the respective thicknesses of the positive electrode layer and the negative electrode layer, in a plane in which the electrode shaped as rectangular sheet extends, are larger in central portions than in peripheral portions.

According to the 4th aspect of the present invention, in a storage battery cell according to the 2nd aspect, it is preferred that the thicknesses of the positive electrode layer and the negative electrode layer are smoothly varied along width direction.

According to the 5th aspect of the present invention, in a storage battery cell according to the 2nd aspect, it is preferred that the thicknesses of the positive electrode layer and the negative electrode layer are varied non-smoothly along width direction.

According to the 6th aspect of the present invention, in a storage battery cell according to the 1st aspect, it is preferred that the electrode group is a wound-type electrode group in which a positive electrode, a negative electrode and a separator, which respectively are shaped as elongate sheets, are wound around, and a thickness of the electrode layer at a winding start edge is larger than a thickness of the electrode layer at a winding end edge.

According to the 7th aspect of the present invention, in a storage battery cell according to the 6th aspect, it is preferred that the thickness of the electrode layer is gradually increased, along a longitudinal direction of the electrode group that is shaped as elongate sheet, from the winding start edge toward the winding end edge.

According to the 8th aspect of the present invention, in a storage battery cell according to the 1st aspect, it is preferred that the electrode group is a wound-type electrode group in which a positive electrode, a negative electrode and a separator, which respectively are shaped as elongate sheets, and a thickness of the electrode layer, in central portion along a width direction of the electrode group that is shaped as elongate sheet, is larger than thicknesses of both edges along the width direction of the electrode group.

According to the 9th aspect of the present invention, in a storage battery cell according to the 2nd aspect, it is preferred that a thickness profile of the separator is complementary to thickness profiles of the positive electrode layer and the negative electrode layer, and the electrode group has a thickness that is constant over an entire region thereof.

According to the 10th aspect of the present invention, in a storage battery cell according to the 1st aspect, it is preferred that the quotients of the positive electrode active material and the negative electrode active material in the electrolyte are controlled depending on respective porosities of the positive electrode layer and the negative electrode layer, and the positive electrode layer and the negative electrode layer have respective regions where the porosities are different from each other in a plane of the electrode group.

According to the 11th aspect of the present invention, an assembled battery comprises: a plurality of storage battery cells according to the 1st aspect; a bus bar that connects the plurality of storage battery cells in series or in series-parallel; and a housing in which the plurality of the storage battery cells are housed, wherein the plurality of the storage battery cells include a first storage battery cell group consisting of a plurality of storage battery cells having small quotients of the positive electrode active material and the negative electrode active material in the electrolyte, and a second storage battery cell group consisting of a plurality of storage battery cells having larger quotients of the positive electrode active material and the negative electrode active material in the electrolyte than the first storage battery cell group.

According to the 12th aspect of the present invention, an assembled battery setup method for setting up an assembled battery according to the 11th aspect, it is preferred that the assembled battery is installed under an environment in which; the first storage battery cell group having small quotients of the positive electrode active material and the negative electrode active material in the electrolyte are arranged close to a first environment of high temperature, whereas the second storage battery cell group having larger quotients of the positive electrode active material and the negative electrode active material in the electrolyte than the first storage battery cell group are arranged close to a second environment of lower temperature than the first environment.

According to the 13th aspect of the present invention, in an assembled battery according to the 11th aspect, it is preferred that the first storage battery cell group having small quotients of the positive electrode active material and the negative electrode active material in the electrolyte is arranged in a first space in the housing, in which heat dissipation performance is low, and the second storage battery cell group having larger quotients of the positive electrode active material and the negative electrode active material in the electrolyte than the first storage battery cell group is arranged in a second space in the housing, in which heat dissipation performance is higher than the first space.

According to the 14th aspect of the present invention, an electrode group for a secondary battery cell, immersed in an electrolyte in a battery cell container, in which a positive electrode including positive electrode current collector foil and a positive electrode layer that contains a positive electrode active material and is provided on the positive electrode current collector foil, a negative electrode including negative electrode current collector foil and a negative electrode layer that contains a negative electrode active material and is provided on negative electrode current collector foil, and a separator that intervenes between the positive electrode and the negative electrode are laminated, wherein the positive electrode active material and the negative electrode active material uniformly distribute in the positive electrode layer and the negative electrode layer, respectively, and the positive electrode layer and the negative electrode layer, in which respectively the positive electrode active material and the negative electrode active material distribute uniformly, are respectively provided with regions where respective quotients of the positive electrode active material and the negative electrode active material in the electrolyte are varied.

According to the 15th aspect of the present invention, in an electrode group for a secondary battery cell according to the 14th aspect, it is preferred that the respective quotients of the positive electrode active material and the negative electrode active material in the electrolyte are controlled depending on respective thicknesses of the positive electrode layer and the negative electrode layer, and the positive electrode layer and the negative electrode layer have respective regions in a plane of the electrode group, in which respective thicknesses of the positive electrode layer and the negative electrode layer are varied.

According to the 16th aspect of the present invention, in an electrode group for a secondary battery cell according to the 14th aspect, it is preferred that the respective quotients of the positive electrode active material and the negative electrode active material in the electrolyte are controlled depending on porosities of the positive electrode layer and the negative electrode layer, and the positive electrode layer and the negative electrode layer have regions in a plane of the electrode group, in which respective porosities are varied.

According to the 17th aspect of the present invention, a production method of electrode group for secondary battery cell, for producing an electrode group for a secondary battery cell according to the 14th aspect, comprises: a step of applying a positive electrode active material and a negative electrode active material on positive electrode current collector foil and negative electrode current collector foil, respectively, so that the positive electrode active material and the negative electrode active material uniformly distribute on positive electrode current collector foil and negative electrode current collector foil, respectively; a step of drying the positive electrode active material and the negative electrode active material applied on the positive electrode current collector foil and the negative electrode current collector foil, respectively; and a step of pressing respectively the positive electrode active material and the negative electrode active layer on the positive electrode current collector foil and the negative electrode current collector foil, after the step of drying, to fabricate a positive electrode layer and a negative electrode layer, so that the regions in which the respective porosities are varied.

According to the 18th aspect of the present invention, in a production method of electrode group for secondary battery cell according to the 17th aspect, it is preferred that in the step of pressing, the respective porosities of the region of the positive electrode layer and the negative electrode layer are controlled by controlling amounts of press against the positive electrode active material and the negative electrode active material, respectively.

According to the 19th aspect of the present invention, a production method of electrode group for secondary battery cell, for producing an electrode group for a secondary battery cell according to the 14th aspect comprises: a step of applying a positive electrode active material and a negative electrode active material onto positive electrode current collector foil and negative electrode current collector foil, respectively, so that the positive electrode active material and the negative electrode active material uniformly distribute in the electrode layers, a step of drying the positive electrode active material and the negative electrode active material applied to the positive electrode current collector foil and the negative electrode current collector foil, respectively; a step of cutting respectively the positive electrode current collector foil and the negative electrode current collector foil on which the positive electrode active material and the negative electrode active material, after the step of drying, are applied to predetermined lengths to form a positive electrode and a negative electrode, respectively; a step of winding the positive electrode and the negative electrode together with a separator that intervenes between the electrodes at a predetermined tensional force, wherein in the step of winding, the predetermined tensional force is controlled so that the regions in which the porosities are varied are formed.

According to the present invention, the amount of heat emission by the battery cells can be controlled without decreasing energy density.

### BRIEF DESCRIPTION OF THE DRAWINGS

FIG. 1 presents a cross-sectional view schematically showing an electrode group representing a storage battery cell according to the present invention;

FIG. 2 presents a graph showing a relationship between the ratio of the amount of the active material to the amount of the electrolyte and the amount of heat generation under the condition that the amount of the active material is constant;

FIG. 3 presents a cross-sectional view of a rectangular sheet 12 along the line III-III, illustrating an electrode group having a maximum thickness of electrode layer in the central portion along the width direction;

FIG. 4 presents a diagram illustrating an electrode group in the form of an elongate sheet having a maximum thickness of electrode layer in the central portion along the width direction;

FIG. 5 presents a horizontal cross-sectional view, schematically illustrating a cylindrical wound-type storage battery cell according to the second embodiment of the present invention;

FIG. 6 presents a cross-sectional view taken in a plane shown by A-B in FIG. 5;

FIG. 7 presents a perspective view showing a laminated-type storage battery cell with tab leads on one side according to a third embodiment of the present invention;

FIG. 8 presents a schematic cross-sectional view taken in a plane shown by VIII-VIII in FIG. 7;

FIG. 9 presents a perspective view showing a laminated-type storage battery cell with tab leads on both sides according to a fourth embodiment of the present invention;

FIG. 10 presents a schematic cross-sectional view taken in a plane shown by X-X in FIG. 9;

FIG. 11A presents a cross-sectional view showing a wound-type prismatic storage battery cell according to a fifth embodiment of the present invention;

FIG. 11B presents a longitudinal cross-sectional view showing an elongate sheet-type electrode group according to the fifth embodiment of the present invention;

FIG. 12 presents a perspective view showing an assembled battery according to a sixth embodiment of the present invention;

FIG. 13A presents a cross-sectional view, schematically showing an electrode in a storage battery cell having a large diameter to be used in an assembled battery.

FIG. 13B presents a cross-sectional view, schematically showing an electrode in a storage battery cell having a small diameter to be used in an assembled battery;

FIG. 14 presents a schematic cross-sectional view showing an electrode in a laminated-type storage battery cell with a plurality of electrode group according to a seventh embodiment of the present invention; and

FIG. 15 presents a cross-sectional view schematically showing an electrode in a storage battery cell according to an eighth embodiment of the present invention.

### DESCRIPTION OF PREFERRED EMBODIMENTS

### First Embodiment

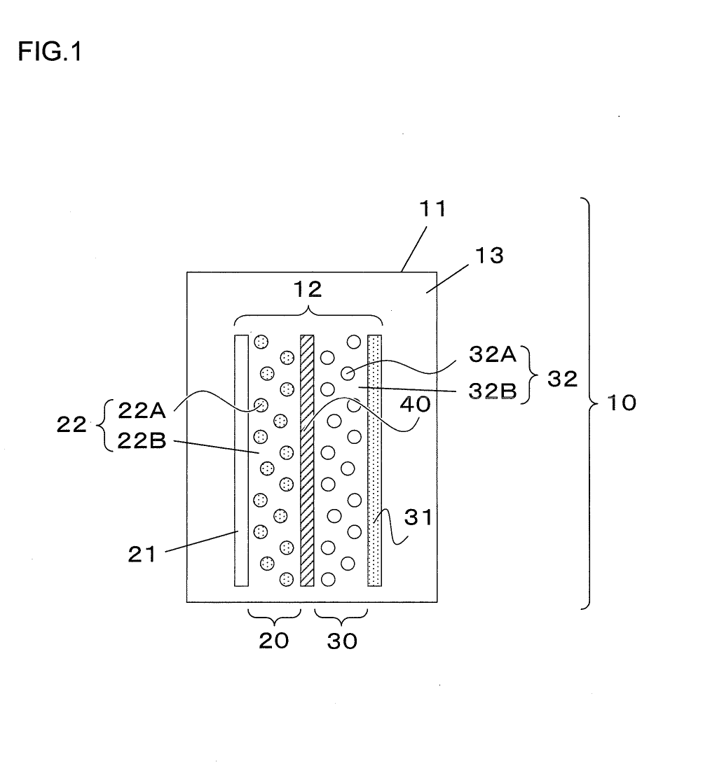

According to the first embodiment, the storage battery cell of the present invention is applied to a lithium ion secondary battery cell. Hereafter, the lithium ion secondary battery cell according to the first embodiment is explained with reference to FIGS. 1 to 3.

FIG. 1 presents a schematic diagram showing a lithium ion secondary battery cell 10 according to the first embodiment. The lithium ion secondary battery cell 10 includes as main constituent elements a battery cell container 1, a laminated-type electrode group 12, and an electrolyte 13 injected in the battery cell container 11 in which the laminated-type electrode group 12 are housed.

The laminated-type electrode group 12 are constituted by a sheet-like positive electrode 20 and a sheet-like negative electrode 30, which are laminated together with a separator 40 that intervenes between the electrodes. The positive electrode 20 is constituted by a positive current collector foil 21, which is a positive electrode metal foil, and a positive electrode layer 22 provided on one surface of the current collector foil 21. The metal foil 21 may be an aluminum foil or an aluminum alloy foil but the present invention should not be construed as being limited to these.

The positive electrode layer 22, which consists of a mixture of a positive active material 22A, a conductive auxiliary agent and a binder 22, is applied on the positive current collector foil 21 so that the positive active material 22A can uniformly distribute in the positive electrode layer 22. Representative examples of the material of the positive active material 22A include lithium cobalt oxide, lithium nickel oxide, lithium manganese oxide and so on. However, the present invention should not be construed as being limited to these. Further, it is possible to use two or more substances. The particle size of the positive active material 22A is made substantially uniform. It is to be noted that in the figure, the positive electrode 22A is depicted in an exaggerated manner.

The negative electrode 30 is constituted by a negative current collector foil 31, which is a negative electrode metal foil, and a negative electrode layer 32 provided on one side of the current collector foil 31. The metal foil 31 may be a copper foil or copper alloy foil. Also, foils of conductive materials such as nickel foil and stainless steel foil may be used.

The negative electrode layer 32, which consists of a mixture of a negative active material 32A, a conductive auxiliary agent and a binder 32B, is applied on the negative current collector foil 31 so that the negative active material 32A can distribute in the negative electrode layer 32 substantially uniformly. Examples of generally used materials of the negative active material 32A include graphite and lithium titanate. However, the present invention should not be construed as being limited to these and the negative electrode active material 32A can be replaced by other materials as appropriate. The particle size of the negative active material 32A is set substantially uniform. It is to be noted that in the figures, the negative electrode 32A is shown in an exaggerated manner.

The fact that the positive active material 22A distributes in the positive electrode layer 22 substantially uniformly or substantially equally means that the amount of the positive active material 22A is constant elsewhere in the positive electrode layer 22. Likewise, the fact that the negative active material 32A distributes in the negative electrode layer 32 substantially uniformly or substantially equally means that the amount of the negative active material 32A is constant elsewhere in the positive electrode layer 22. As mentioned above, by setting constant the amount of the active material in the electrode layer, the current density can be made constant over the entire region of the electrode group.

The separator 40 must have a function of preventing direct contact between the positive electrode 22 and the negative electrode 32, and a function of maintaining ion conductive property. In batteries in which the electrolyte 13 is present, a porous material having pores is used as the separator. Representative examples of material for the porous material include polyolefin, polyethylene and polypropylene. However, the present invention should not be construed as being limited to these.

The electrode group 12 is immersed in the electrolyte 13 in the battery cell container 11. The electrolyte 13 serves as an ion conductive phase. In a lithium ion battery cell, a non-aqueous solution electrolyte is used as the electrolyte 13. The electrolyte in the lithium ion battery cell is constituted by a lithium salt, such as LiPF₆ or LiClO₄, and a solvent, such as ethylene carbonate or diethyl carbonate. The electrolyte 13 may be not only a liquid or a gel but also a solid.

The positive electrode 20 and the negative electrode 30 may be fabricated each in the form of a circular sheet, a rectangular sheet, or an elongate sheet. The lithium ion secondary battery cell 10 according to the first embodiment includes the battery cell electrodes (so-called laminated-type electrodes) laminating a plurality of electrode groups 12, each of which is constituted by the rectangular sheet-like electrodes 20, 30 and the separator 40 that is inserted between the electrodes. The lithium ion secondary battery cell 10 of this construction can secure a large electrode area to increase power density.

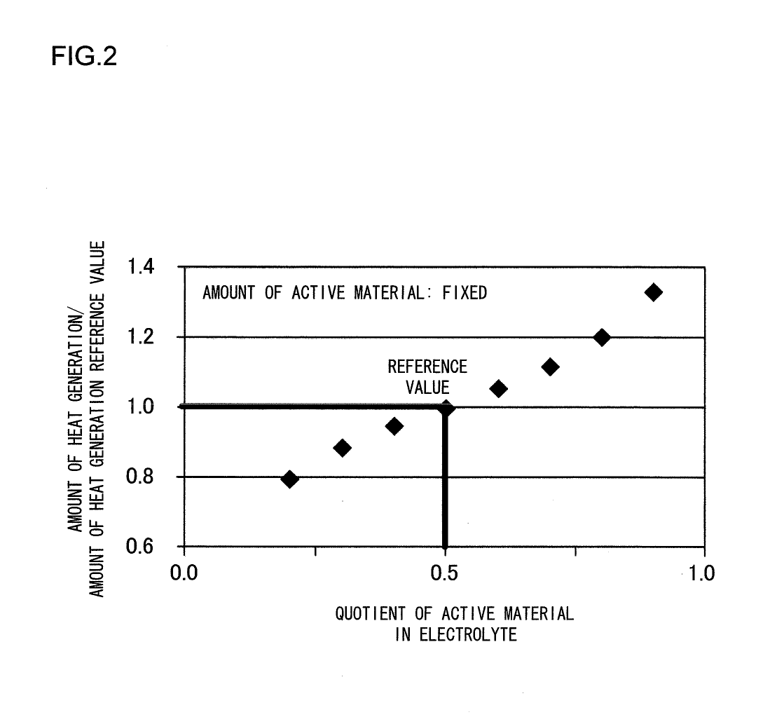

As mentioned above, the electrode group 12 is immersed in the electrolyte 13. The inventors of the present invention have found a relationship between a ratio of the amount of the active material immersed in the electrolyte and the amount of heat emission, as shown in FIG. 2. The lithium ion secondary battery cell 10 according to the first embodiment is configured based on this finding as explained in detail below.

FIG. 2 presents a graph plotting heat generation amount by eight different lithium ion secondary battery cells which contain different active materials quotients in electrolyte when electric charges of the electrode layer in each of the battery cells is discharged under predetermined discharging conditions. The battery cells were fabricated so that weights of the positive electrode active material 22A and the negative electrode active material 32A contained in the respective electrode layers are the same, the particle sizes are substantially equal and the active materials distribute uniformly in the respective electrode layers. Since such a plurality of storage battery cells have a substantially equal terminal voltage and a substantially equal discharge time, the discharging properties under all the conditions are substantially the same.

FIG. 2 presents a graph plotting the active material quotient in the electrolyte along the horizontal axis vs. the heat generation amount divided by a reference heat generation value along the vertical axis. The vertical axis is an index for normalizing the amount of heat emission. The reference value of amount of heat emission is defined to be 1.0 when the active material quotient in electrolyte is 0.5.

As shown in FIG. 2, when the positive active material quotient in the electrolyte 13 and the negative active material quotient in the electrolyte 13 is increased, the amount of heat generation of the electrode group 12 increases. Conversely, when the positive active material quotient in the electrolyte 13 and the negative active material quotient in the electrolyte 13 is decreased, the amount of heat generation of the electrode group 12 decreases.

Explanation is made in more detail as follows. By decreasing the respective active materials quotients 22A, 32A to in the electrolyte 13 from 50% to 20%, the amount of heat generation of the electrode group 12 decreases by 20%. On the other hand, by increasing the active materials quotients 22A, 32A in the electrolyte from 50% to 80%, the amount of heat generation of the electrode group 12 increases by 20%.

The active material quotient in the electrolyte can be changed with various methods. In the case of the lithium ion secondary battery cell 10 according to the first embodiment, the negative electrode layer 32 has a varied thickness that is varied smoothly along the width direction, with the negative active material 32A distributed uniformly, so that the thickness of a central portion along the width direction is maximal. The separator 40 is configured to have a thickness that varies depending on variation of thicknesses of the positive and negative electrode layers 22, 32. More particularly, the separator 40 is thin for those portions of the positive and negative electrode layers 22, 32 having a large thickness whereas the separator 40 is thick for those portions of the positive and negative electrode layers 22, 32 having a small thickness. As a result, the thickness of the laminated-type electrode group 12 becomes uniform along the width direction.

The effects of the electrode group 12 according to the first embodiment thus configured are explained in comparison with conventional electrode groups having the same predetermined discharging properties when used in a lithium ion secondary battery cell. Here, the conventional electrode groups are those electrode groups whose electrode layers have a constant thickness along the width direction.

(1) Temperature elevation of the laminated-type electrode group 12 causes deterioration of the positive electrode active material 22A and the negative electrode active material 32A, and also causes internal short-circuit. The conventional laminated-type electrode group whose electrode layers have each a constant thickness along the width direction has more inferior heat dissipation performance in the central portion (inside the battery cell) than at both ends. That is, the central portion of the electrode group shows a large increase in temperature. The electrode group 12 according to the first embodiment has the maximum thickness in the central portion thereof along the width direction, so that the amount of heat generation at the central portion is smaller than the amount of heat generation at the peripheral portion. If the weights of the positive electrode active material 22A and of the negative electrode active material 32A that constitute the electrode layer 20 are set to be same as the weights of the active materials in the conventional storage battery cell for comparison, the temperature distribution in the inside of a storage battery cell of the invention can be decreased while keeping the discharging property of the storage battery cell of the invention, which is determined by energy density or power density, comparable to those of the conventional storage battery cell.

(2) The respective densities of the active materials are controlled to be constant in any region of the electrode layer 20, so that the discharge capacity becomes constant in any region of the electrode group. Therefore, if the thickness of the electrode layer is constant, the amount of heat generation upon charge and discharge is constant over the whole region. In regions of the electrode group where heat dissipation performance is lower when the electrode group is incorporated in a storage battery cell, the respective quotients of the active materials in the electrolyte are set smaller. On the contrary, in regions of the electrode group where heat dissipation performance is higher when the electrode group is incorporated in a storage battery cell, the respective quotients of the active materials in the electrolyte are set larger. As a result, the electrode group has no regions where local temperature elevation occurs, so that there is no possibility of causing local deterioration of the electrode group.

(3) By decreasing the temperature distribution in the inside of the battery cell, it is possible to avoid the local deterioration of the battery cell, so that a prolonged service life of the battery cell can be achieved.

(4) The thickness form of the separator 40 is in complementary relationship with the thickness forms of the positive and negative electrode active materials 22, 32, so that the electrode group 12 has a constant thickness over the whole region. As a result, processes of lamination and winding are easier, and the workability for assembly of electrode group into a storage battery cell is very good.

It is to be noted that the electrode group according to the first embodiment is fabricated by providing an electrode layer on one side of each of the positive current collector foil and the negative current collector foil. However, a storage battery cell fabricated by providing an electrode layer on both sides of each of the positive current collector foil and the negative current collector foil can exhibit similar effects to those of the storage battery cell according to the first embodiment.

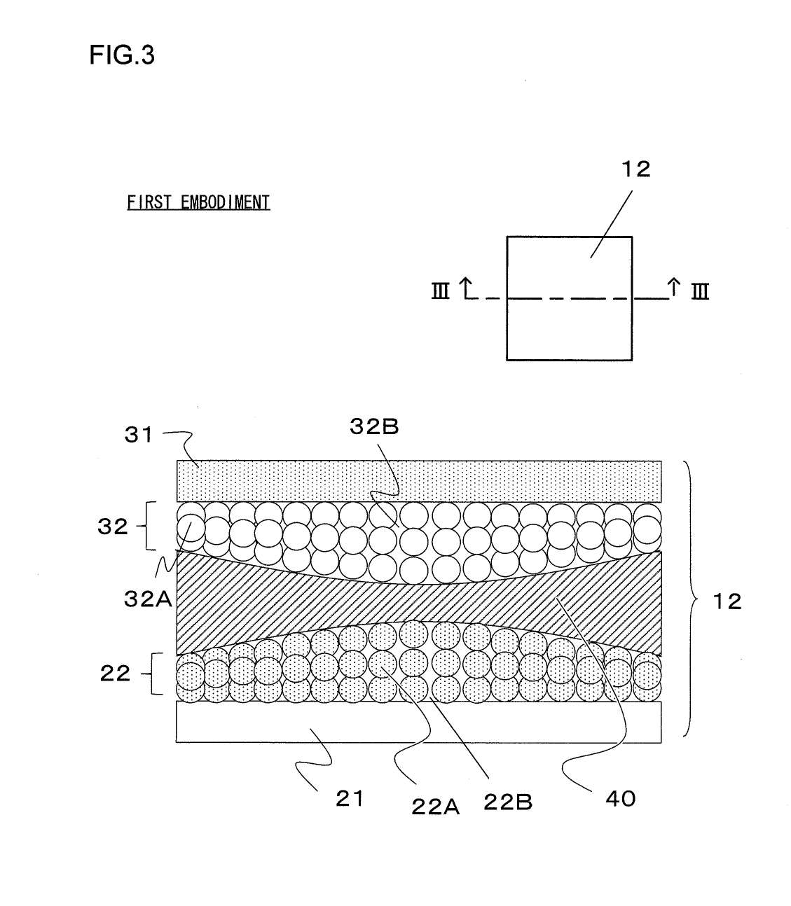

The electrode group according to the first embodiment is fabricated in the form of a rectangular sheet and is used as an electrode group for a so-called laminated-type lithium ion secondary battery cell. However, the electrode group may be fabricated into an elongate sheet. In case that the present invention is applied to the electrode group 12 in the form of an elongate sheet, the electrode group 12 is fabricated in the form of a sheet whose shorter side direction corresponds to the horizontal direction of the cross-section in FIG. 3 and whose longer side direction corresponds to the direction vertical to the plane of paper of FIG. 3. The electrode group in the form of an elongate sheet can be wound into a cylinder for use in a cylindrical lithium ion secondary battery cell or in the form of a flat rectangle for use in a prismatic lithium ion secondary battery cell.

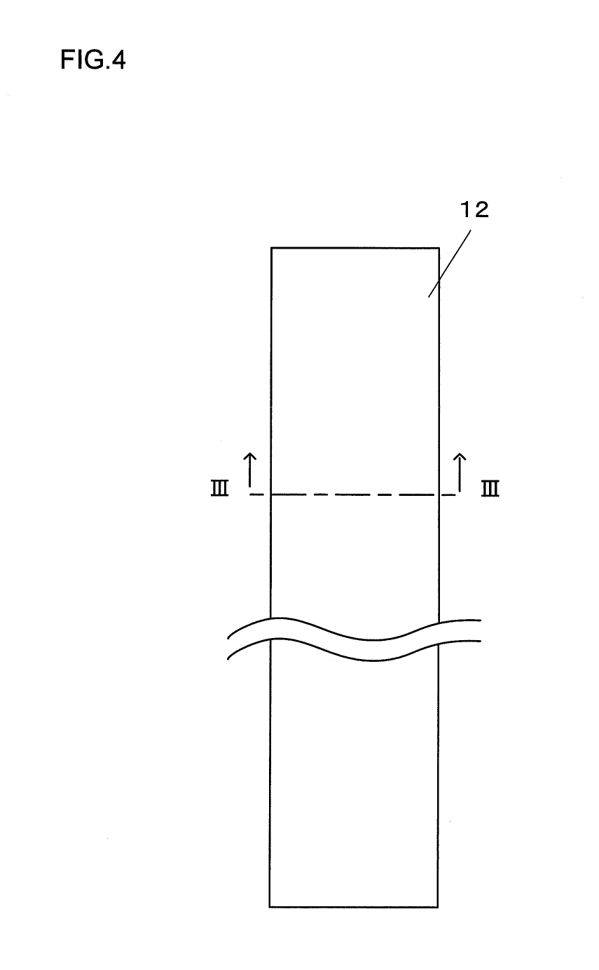

The electrode group according to the first embodiment as explained above, which is fabricated by laminating rectangular sheet-shaped positive and negative electrodes or by winding elongate sheet-shaped positive and negative electrodes, can be applied to lithium ion secondary battery cells of various forms regardless of the shape of the battery cell container. Therefore, the electrode group according to the first embodiment can be applied to, for example, the above-mentioned laminated-type lithium ion secondary battery cell, a wound-type cylindrical lithium ion secondary battery cell achieved by winding the electrode group in the form of an elongate sheet shown in FIG. 4, a wound-type flat lithium ion secondary battery cell achieved by winding the electrode group in the form of an elongate sheet shown in FIG. 4, and various lithium ion secondary battery cells having other shapes.

### Second Embodiment

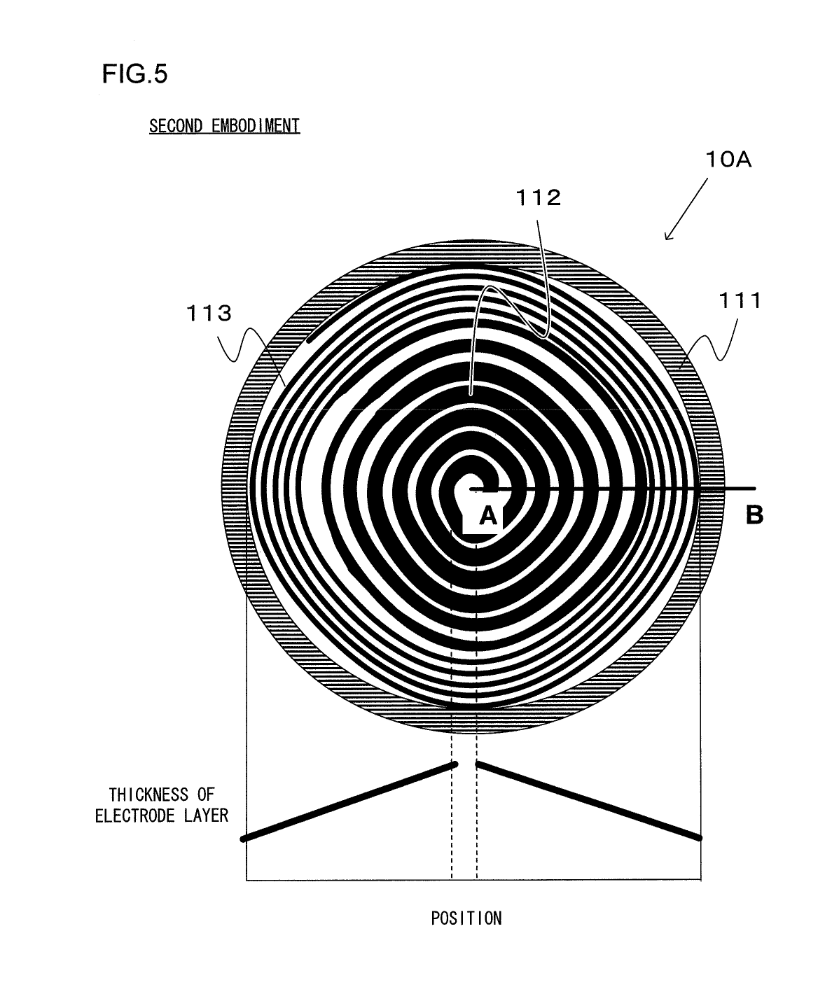

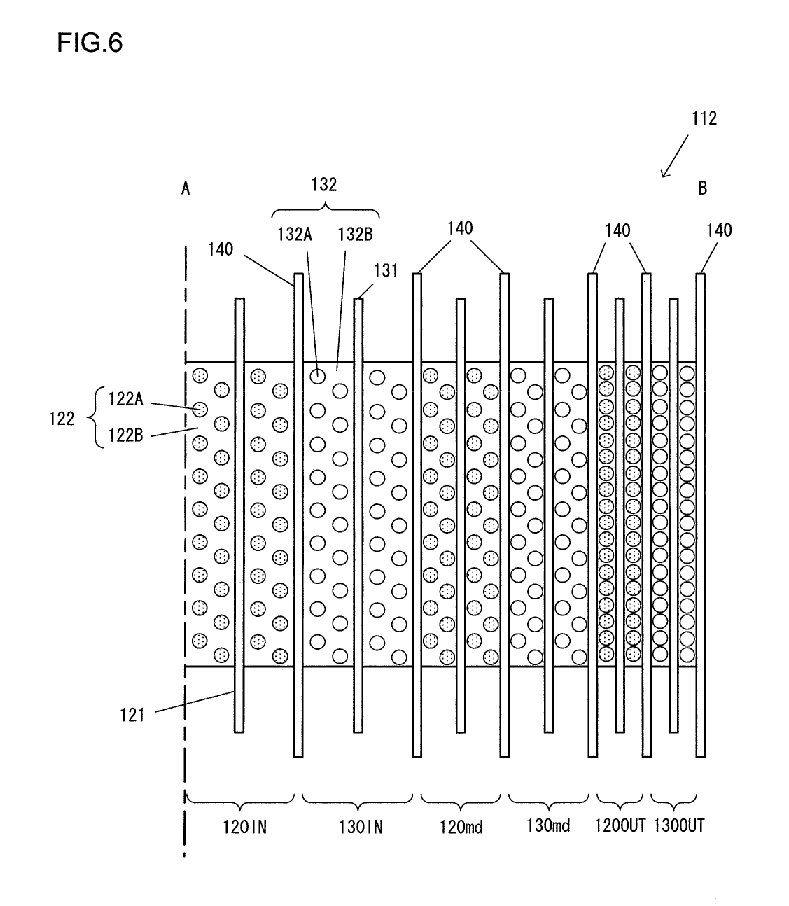

The storage battery cell according to a second embodiment of the present invention is explained with reference to FIGS. 5 and 6. In the figures, parts that are the same as or corresponding to parts of the first embodiment are assigned with numerals in the 100s and explanation is made concentrating on differences between the first and second embodiments. According to the second embodiment, the present invention is applied to a cylindrical wound-type storage battery cell. The electrode group used in this embodiment is in the form of an elongate sheet similar to the electrode group shown in FIG. 4 except that the thickness of the electrode layer is gradually increased or decreased along the longitudinal direction instead of the width direction.

In FIGS. 5 and 6, a cylindrical wound-type storage battery cell 10A is constituted by housing a laminated-type electrode group 112 that is wound around a winding core (not shown) in a container 111 and injecting an electrolyte 113 in the container 111. The laminated-type electrode group 112 is constituted by a positive electrode 120 and a negative electrode 130 each in the form of an elongate sheet wound around a winding axis (not shown) together with a separator 140 that intervenes between the electrodes.

The positive electrode 120 includes a positive electrode metal foil 121 and a positive electrode layer 122 provided on both sides of the positive electrode metal foil 121. The metal foil 121 may be aluminum foil or aluminum alloy foil. The negative electrode 130 is constituted by a negative current collector foil 131 and a negative electrode layer 132 provided on both sides of the current collector foil 131. The metal foil 31 may be a copper foil or copper alloy foil. Also, foil of conductive materials such as nickel foil and stainless steel foil may be used.

The positive electrode layer 122, which consists of a mixture of a positive active material 122A, a conductive auxiliary agent and a binder 122B, is applied on the positive current collector foil 121 so that the positive active material 122A can uniformly distribute in the positive electrode layer 122. The negative electrode layer 132, which consists of a mixture of a negative active material 132A, a conductive auxiliary agent and a binder 132B, is applied on the negative current collector foil 131 so that the negative active material 132A can distribute in the negative electrode layer 132 uniformly. It is to be noted that FIGS. 5 and 6 are schematic diagrams and in the figures, the negative electrode 132A is shown in an exaggerated manner.

The separator 140 must prevent direct contact between the positive electrode 122 and the negative electrode 132, and needs to maintain ion conductive property. In a battery cell in which the electrolyte 113 is present, a porous material having pores is used. Representative examples of the porous material include polyolefin, polyethylene and polypropylene. However, the present invention should not be construed as being limited to these.

The wounded electrode group 112 are housed in the battery cell container 111 and the electrolyte 113 is injected in the container 111 to constitute the storage battery 10A. The container 111 may be, for example, a nickel-plated iron can.

In the electrode group 112 according to the second embodiment, as shown in the schematic diagram presented in FIG. 6, the electrode layers 122, 132 are structured to have larger thicknesses as they are positioned closer to the central portion of the winding. Since the cylindrical wound-type storage battery cell 10A has a structure such that heat is dissipated from the outer surface of the battery container 111, which is positioned at the outermost periphery of the laminated-type electrode group 112, the temperature is higher in the central portion of winding of the storage battery cell 10A (indicated by sign A) than the temperature in other portions. Therefore, according to the present embodiment, the thicknesses of the positive electrode layer 122 and the negative electrode layers 132 in the laminated-type electrode group 112 are set to be gradually larger from the outer peripheral end toward the central portion A to gradually decrease the respective quotient of the positive active material 122A and the negative active material 132A in the electrolyte 113 accordingly.

FIG. 6 shows a laminated-wounded electrode group 112, in which an innermost positive electrode 120in, an innermost peripheral negative electrode 130in, a middle positive electrode 120md, a middle negative electrode 130md, an outermost peripheral positive electrode 120out, and an outermost peripheral negative electrode 130out are arranged between the central portion of winding (winding start edge) A and the outer peripheral portion (winding end edge) B. The respective thicknesses of the innermost positive electrode 120in and the innermost peripheral negative electrode 130in are larger than the respective thicknesses of the middle positive electrode 120md, the middle negative electrode 130md, the outermost peripheral positive electrode 120out, and the outermost peripheral negative electrode 130out. The respective thicknesses of the middle positive electrode 120md and the middle negative electrode 130md are larger than the respective thicknesses of the outermost peripheral positive electrode 120out and the outermost peripheral negative electrode 130out.

The cylindrical storage battery cell exhibits a large increase in temperature since its portion closer to the winding core has lower heat dissipation performance. Therefore, in the wound-type storage battery cell according to the second embodiment, the thickness of the laminated electrode group 112 is varied along the length direction so that the electrode layers 122, 132 have larger thicknesses at positions closer to the winding core side to make the respective quotients of the active materials 122A, 132 in the electrolyte 113 smaller toward the winding core. In other words, the electrode layers 122, 132 are structured such that the amounts of heat generated by the electrode layers 122, 132 per se are smaller toward the central portion thereof. As a result, the temperature distribution is decreased over the whole storage battery cell, there occurs no local heat generation, local deterioration of electrode group can be avoided, and the service life of the storage battery cell can be prolonged.

Hereafter, a production method of the electrode group 112 by which the thicknesses of the positive and negative electrode layers 122, 132 are made larger toward the winding center is explained. The wound-type electrode group is fabricated by winding the laminated-type electrode group 112 produced as an elongate sheet around a winding core center. In the laminated-type electrode group 112 produced as an elongate sheet, before it is wound, the thicknesses of the electrode layers 122, 132 are constant over the entire length of the elongate sheet. When the laminated-type electrode group 112 is wound by a winding apparatus, it is given tension by the winding apparatus. According to the second embodiment, when the laminated-type electrode group 112 is wound, low tension is applied to the electrode group 112 in an initial stage of the winding to increase the thicknesses of the electrode layers 122, 132 and then increasing tension is applied as the winding proceeds to decrease the thicknesses of the electrode layers 122, 132.

It is to be noted that when a so-called flat-wound-type storage battery cell is fabricated by winding the electrode group 112 according to the second embodiment into a flat rectangular shape, effects similar to those of the cylindrical wound-type battery cell can be obtained.

When the electrode group in the form of an elongate sheet having a varied thickness of each of the electrode layers along the width direction as shown in FIG. 3 is used as a wound-type electrode group, the thicknesses of the electrode layers may be gradually increased starting from the winding end edge portion to the winding start edge portion. In this case, the tendency of larger heat generation is relaxed not only in the central portion along the width direction of the elongate sheet but also the tendency of larger heat generation is relaxed on the side of the winding center.

### Third Embodiment

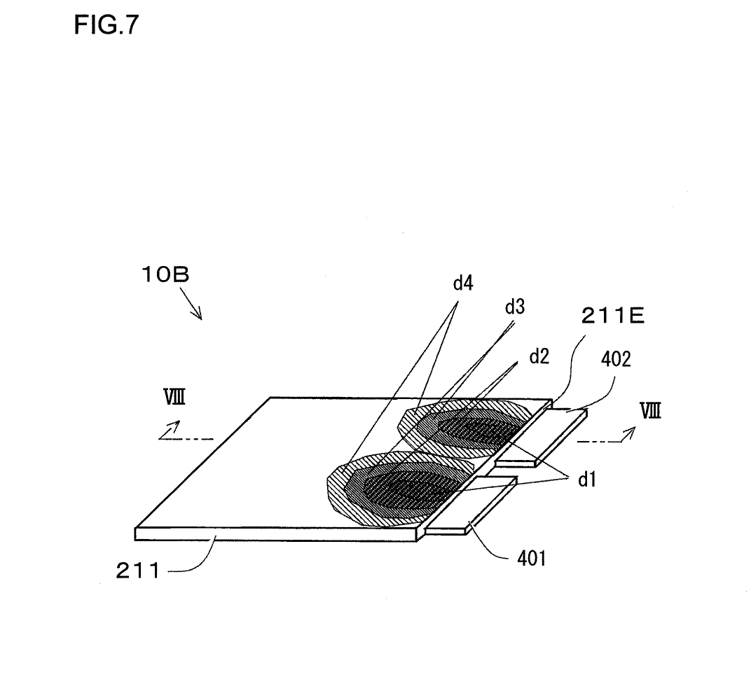

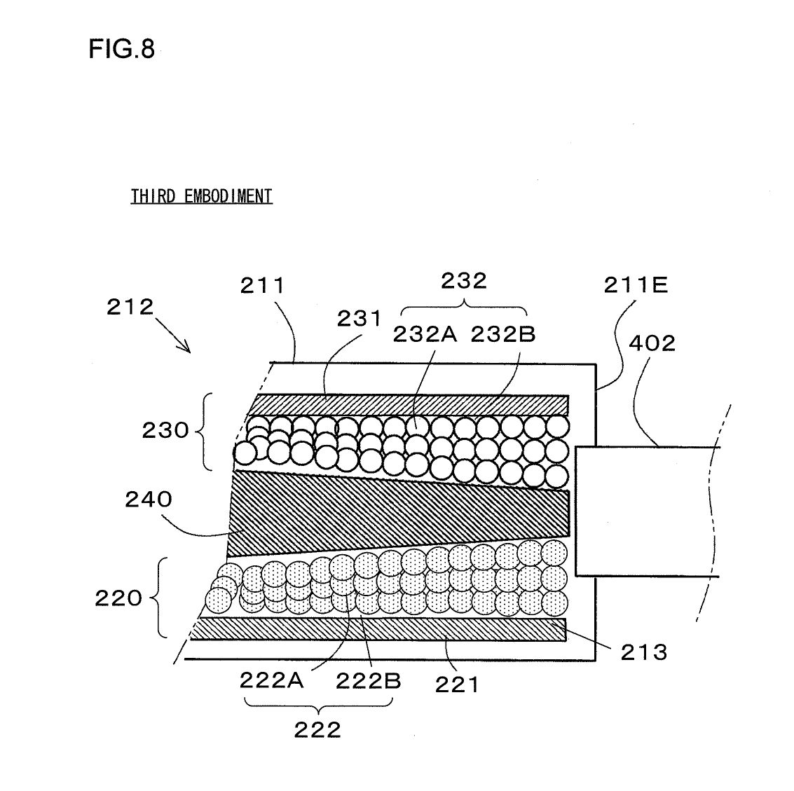

A storage battery cell according to a third embodiment of the present invention is explained with reference to FIGS. 7 and 8. It is to be noted that in the figures, parts that are the same as or corresponding to parts of the first embodiment are assigned with numerals in the 200s and explanation is made concentrating on differences between the first and second embodiments.

According to the third embodiment, the present invention is applied to a laminated-type storage battery cell provided with tabs that are used as external terminals, in which a positive electrode tab and a negative electrode tab are provided on one end of the battery cell.

In FIGS. 7 and 8, a laminated-type storage battery cell with tabs 10B includes a plate-like container 211, which houses therein a laminated-type electrode group 212 fabricated by laminating a positive electrode 220, a negative electrode 230 and a separator 240 that intervenes between the electrodes. A positive electrode tab 401 connected to a positive electrode current collector foil 221 and a negative electrode tab 402 connected to a negative electrode current collector foil 231 are provided at one and the same end 211E of the container 211 so as to protrude therefrom.

It is to be noted that in FIG. 8, a negative electrode tab 402 is depicted as a separate component from a negative electrode metal foil 231 in order to simplify the figure. Actually, a plurality of negative electrode metal foils 231 in the electrode group 212 are bundled and welded to the negative electrode tab 402. The same is true in the case of the positive electrode tab 401.

In the laminated-type storage battery cell 10B, charge and discharge currents flow through the positive electrode tab 401 and the negative electrode tab 402. As a result, current density is high near the positive electrode tab 401 and the negative electrode tab 402 in the laminated-type electrode group 212. In FIG. 7, current density distributions d1 to d4 (d1<d2<d3<d4) in the laminated-type electrode group 212 are shown as hatched figures.

Accordingly, as shown in FIG. 8, the positive electrode layer 222 and the negative electrode layer 232 are constructed to have respective thicknesses that are gradually increased toward the end face 211E in order to decrease the respective quotients of the active materials 222A, 232A in the electrolyte 213, so that the amount of heat generation by the laminated-type electrode group 112 can be suppressed. This suppresses temperature elevation due to high current density near the positive electrode tab 401 and the negative electrode tab 402 to make it possible to prevent local deterioration and internal short-circuit of the laminated-type electrode group 212.

As mentioned above, in the laminated-type storage battery cell with tab 10B according to the third embodiment, the respective thicknesses of the electrode layers 222, 232 are made larger in predetermined regions near the tabs 401, 402, the thicknesses of the electrode layers 222, 232 are larger as they are closer to the tabs. As a result, the temperature distribution in the electrode group 212 can be decreased, so that a lithium ion storage battery cell exhibiting a slow deterioration.

FIG. 8 shows an example of the electrode group 212 in which the respective thicknesses of the electrode layers are increased toward the tab leads 401, 402. However, the thicknesses of the electrode layers may be increased non-smoothly or stepwise toward the tab leads 401, 402, providing similar effects.

### Fourth Embodiment

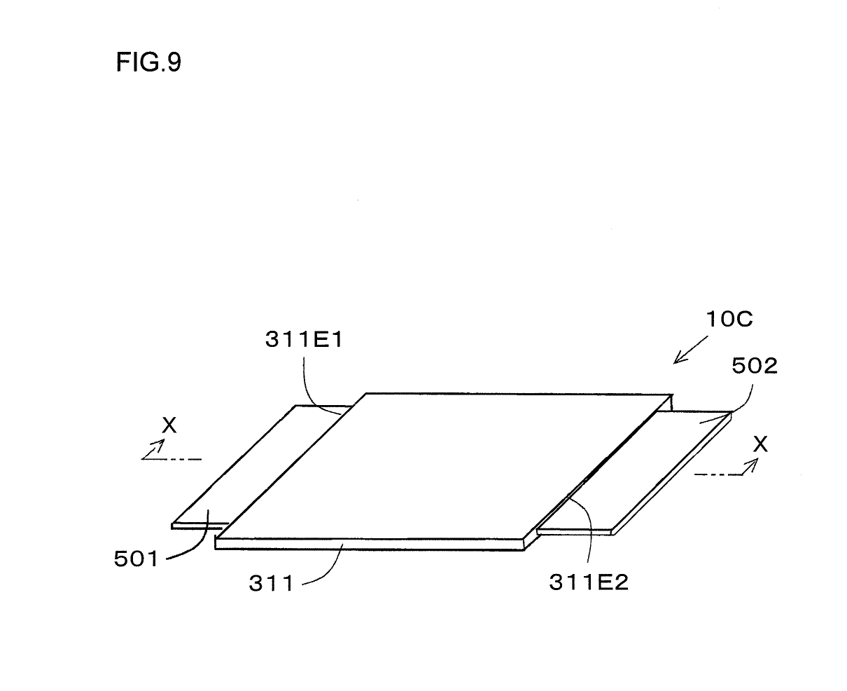

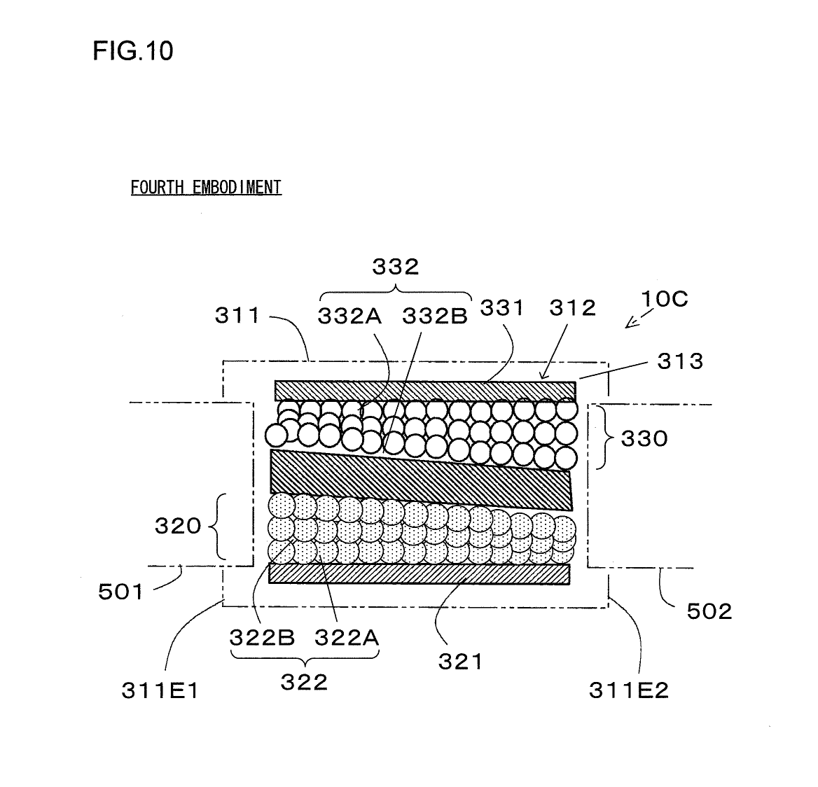

A storage battery cell according to a fourth embodiment of the present invention is explained with reference to FIGS. 9 and 10. It is to be noted that in the figures, parts that are the same as or corresponding to parts of the first embodiment are assigned with numerals in the 300s and explanation is made concentrating on differences between the first and fourth embodiments.

According to the fourth embodiment, the present invention is applied to a laminated-type storage battery cell with tabs that are used as external terminals, in which a positive electrode tab and a negative electrode tab are provided on opposite sides.

In FIG. 9, a laminated-type storage battery cell with tabs 10C includes a plate-like container 311, which houses therein a laminated-type electrode group 312 fabricated by laminating a positive electrode 320 and a negative electrode 330. A positive electrode tab 501 connected to positive electrode current collector foil 321 and a negative electrode tab 502 connected to negative electrode current collector foil 331 are provided at end faces 311E1 and 311E2 of the container 311, which are symmetrically positioned, so as to protrude from the end faces.

It is to be noted that in FIGS. 9 and 10, the tabs 501, 502 are depicted as separate components from the positive electrode metal foil 321 and the negative electrode metal foil 331 in order to simplify the figure. Actually, a plurality of sheets of positive electrode metal foil 321 and a plurality of sheets of negative electrode metal foil 331 in the electrode group 312 are bundled, respectively, and welded to the positive electrode tab 501 and the negative electrode tab 502, respectively.

In the laminated-type storage battery cell 10C, charge and discharge currents flow through the positive electrode tab 501 and the negative electrode tab 502. As a result, current density is relative high near the positive electrode tab 501 and the negative electrode tab 502 in the laminated-type electrode group 312.

Accordingly, as shown in FIG. 10, the positive electrode layer 322 and the negative electrode layer 332 are constructed to have respective thicknesses that are gradually increased toward the end faces 311E, 311E2 in order to decrease the respective quotients of the active materials 322A, 332A in the electrolyte 313, so that the amount of heat generation by the laminated-type electrode group 312 can be suppressed. This suppresses the temperature elevation due to high current density near the positive electrode tab 501 and the negative electrode tab 502 to make it possible to prevent local deterioration and internal short-circuit of the laminated-type electrode group 312.

As mentioned above, in the laminated-type storage battery cell with tabs 10C according to the fourth embodiment, the respective thicknesses of the electrode layers 322, 332 are made larger in predetermined regions near the tabs 501, 502. In particular, the respective thicknesses of the electrode layers 322, 332 are larger near the tabs. As a result, the temperature distribution in the electrode group 212 can be decreased, so that a lithium ion storage battery exhibiting a slow deterioration can be achieved.

FIG. 10 shows an example of the electrode group 312 in which the respective thicknesses of the electrode layers are increased toward the tabs 501, 502. However, the respective thicknesses of the electrode layers may be increased non-smoothly or stepwise toward the tabs 501, 502, providing similar effects.

### Fifth Embodiment

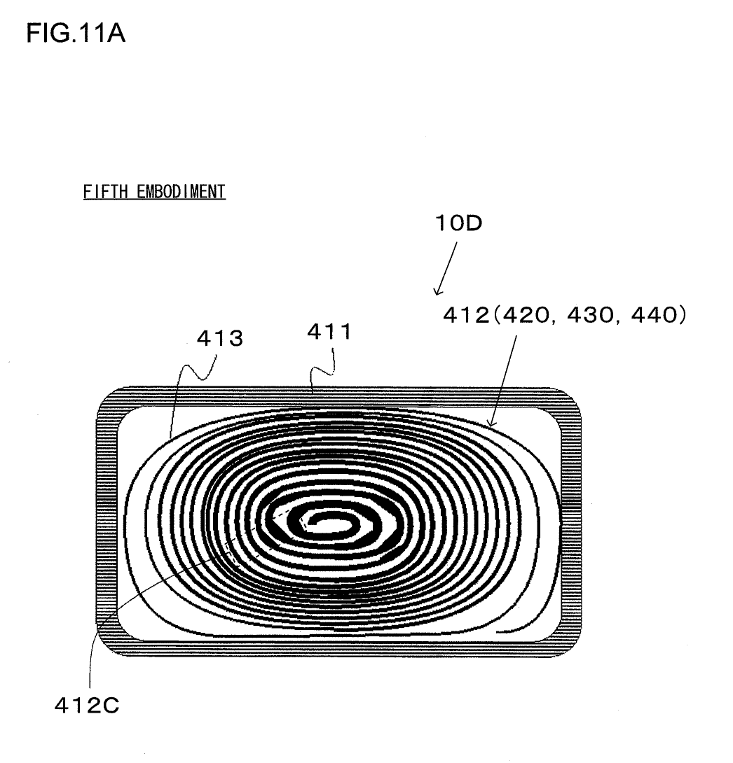

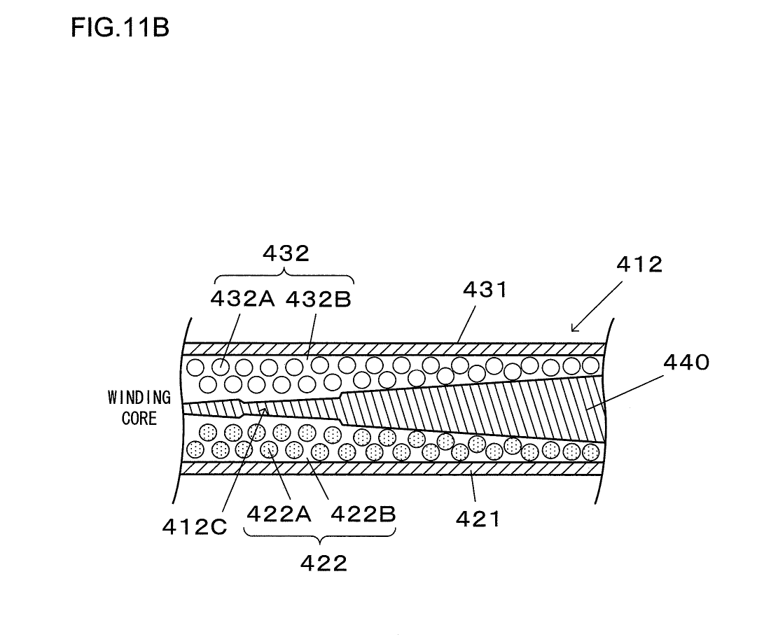

A storage battery cell according to a fifth embodiment of the present invention is explained with reference to FIGS. 11A and 11B. It is to be noted that in the figures, parts that are the same as or corresponding to parts of the first embodiment are assigned with numerals in the 400s and explanation is made concentrating on differences between the first and fifth embodiments. According to the fifth embodiment, the present invention is applied to a prismatic wound-type storage battery cell.

In FIGS. 11A and 11B, a prismatic wound-type storage battery cell 10D includes a container 411 which houses therein a laminated-type electrode group 412 that is wound around a winding core (not shown). The container 411 is filled with electrolyte 413. Though not shown, the electrode group 412 is constituted by winding a positive electrode 420 and a negative electrode 430 together with a separator 440 that intervenes between the electrodes to form a flat prismatic shape. The positive electrode 420 is fabricated by providing a positive electrode layer 422 on positive electrode metal foil 421 and the negative electrode 430 is fabricated by providing a negative electrode layer 432 on negative electrode metal foil 431. The materials of the metal foils and materials of the positive electrode active material and negative electrode material are the same as those used in the first to fourth embodiments. The fifth embodiment is featured by the electrode layers 420, 430 each in the form of an elongate sheet having a controlled thickness along the longitudinal direction. Hereafter, the fifth embodiment is explained.

In case of a prismatic wound-type storage battery 10D, the positive electrode layer 422 and the negative electrode layer 432 tend to be collapsed and could be peeled off at a corner portion 412C with large curvature of the laminated-type electrode group 412. Therefore, in the corner portion 412C, the respective quotients of the active materials 422A, 432A in the electrolyte 413 tend to be increased. Further, similarly to the cylindrical storage battery cell, the prismatic wound-type storage battery cell 10D has a structure with which heat dissipation takes place through the container 411, so that the temperature of the central portion of the battery cell increases.

Accordingly, as shown in FIG. 11B, the respective thicknesses of the positive electrode layer 422 and the negative electrode layer 432 in the laminated-type electrode group 412 are made larger in regions near the winding core and the respective thicknesses of the positive electrode layer 422 and the negative electrode layer 432 in the corner portion 412C near the winding core and having large curvature are made larger than in regions other than the corner portion. As a result, in the electrode layer 422 in the region near the winding core, as compared with a region other than the region near the winding core, respective quotients of the positive electrode active material 422A and the negative electrode active material 432A in the electrolyte 413 are decreased. In addition, in the corner portions 412C of the electrode layers 422, 432 near the winding core, the respective quotients of the positive electrode active material 422A and the negative electrode active material 432A in the electrolyte 413 are further decreased as compared with the region other than the corner portions near the winding core.

This results in that the amount of heat generation in regions close to the winding core of the wound-type electrode group 412 is decreased and even if peeling of the electrode layers 422, 432 occurs at the corner portions 412C, heat generation by the active materials can be suppressed. As a result, the temperature distribution can be made uniform over the entire electrode group 412.

It is to be noted that FIG. 11B schematically shows that portions of the electrode layers that are closer to the winding core have larger thicknesses and that the thicknesses of the corner portions of the electrode layers are made larger than the thicknesses of the surrounding portions. Actually, as shown in FIG. 6, an electrode layer is provided on each side of a current collector foil and the foil provided with the electrode layers is wound under a controlled tension so that the electrode layer is configured to have a larger thickness toward the winding core. Then the respective thicknesses of the electrode layers are increased at portions corresponding to corner portions. The separator that is provided between the positive electrode and the negative electrode is configured to have a thickness complementary to the thicknesses of the electrodes, so that the electrode group in whole has a constant thickness.

### Sixth Embodiment

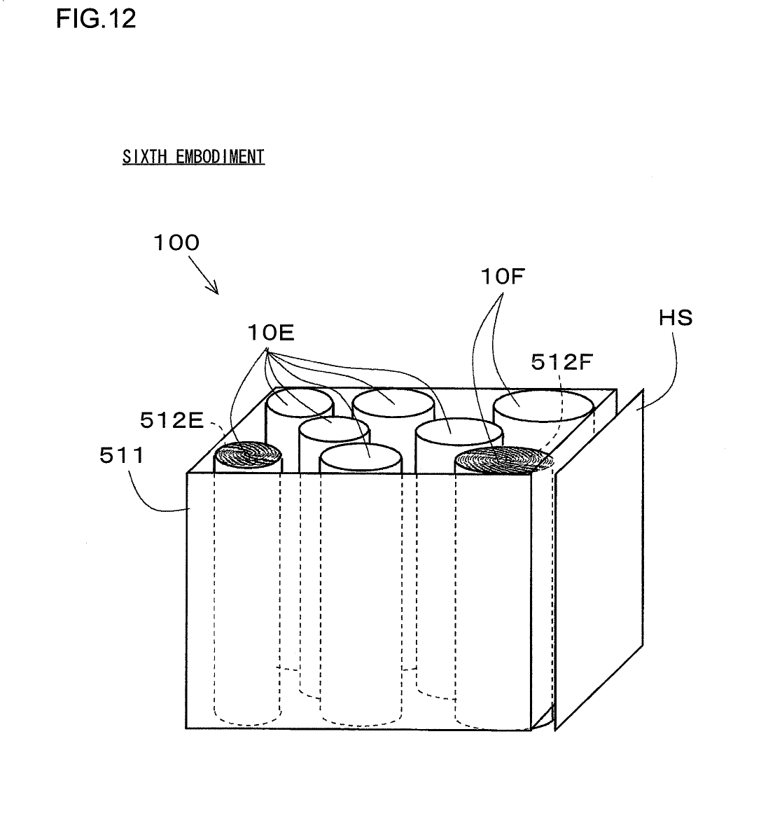

According to a sixth embodiment, the present invention is applied to an assembled battery. The assembled battery according to the sixth embodiment is explained with reference to FIG. 12. It is to be noted that in the figure, parts that are the same as or corresponding to parts of the first embodiment are assigned with numerals in the 500s and explanation is made concentrating on differences between the first and sixth embodiments.

FIG. 12 presents a schematic diagram of an assembled battery 100. The assembled battery 100 includes a plurality of cylindrical storage battery cells 10E having a smaller diameter and a plurality of cylindrical storage battery cells 10F having a larger diameter, connected to each other in series or in series-parallel. That is, the assembled battery 100 includes the plurality of storage battery cells 10E, 10F, a plurality of bus bars (not shown) for connecting the plurality of storage battery cells 10E, 10F in series or in series-parallel, and a housing 511 that houses therein the plurality of storage battery cells 10E, 10F. The assembled battery 100 according to the sixth embodiment is configured to include a group consisting of a plurality of storage battery cells 10F having relatively small quotients of the positive electrode active material and the negative electrode active material in the electrolyte and a group consisting of a plurality of storage battery cells 10E having relatively large quotients of the positive electrode active material and the negative electrode active material in the electrolyte.

When the assembled battery 100 is mounted in an electric vehicle or a hybrid electric vehicle, a heat source HS may be arranged near the assembled battery 100 as shown in FIG. 12. In the assembled battery 100 according to the sixth embodiment, a plurality of cylindrical storage battery cells 10F having a relatively large diameter are arranged at places near the heat source HS and a plurality of cylindrical storage battery cells 10E having a relatively smaller diameter are arranged at places remote from the heat source HS. The cylindrical storage battery cell 10F having a relatively large diameter generates a smaller amount of heat than the cylindrical storage battery cell 10E having a relatively smaller diameter. The cylindrical storage battery cells 10E, 10F are configured to have an equivalent energy density and an equivalent power density as well as equal discharge property.

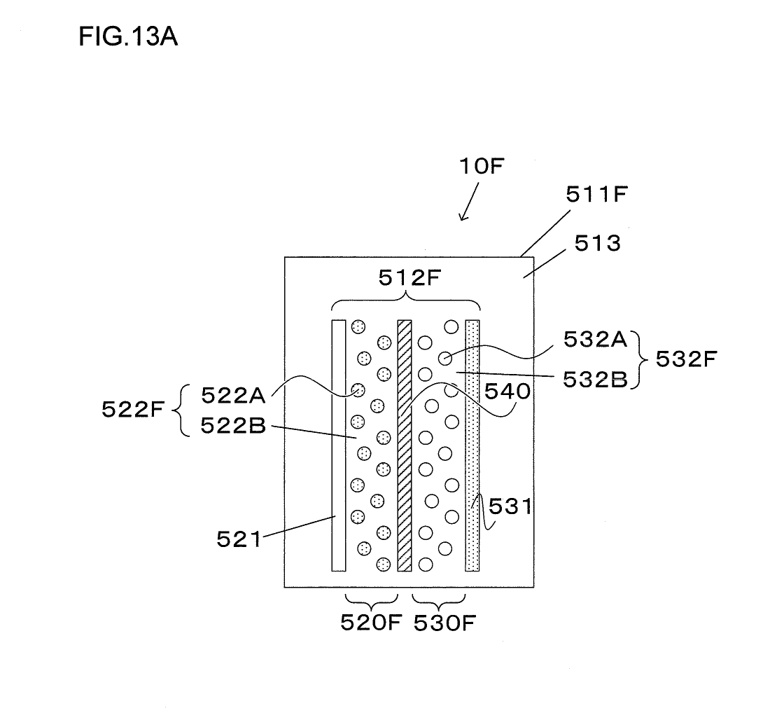

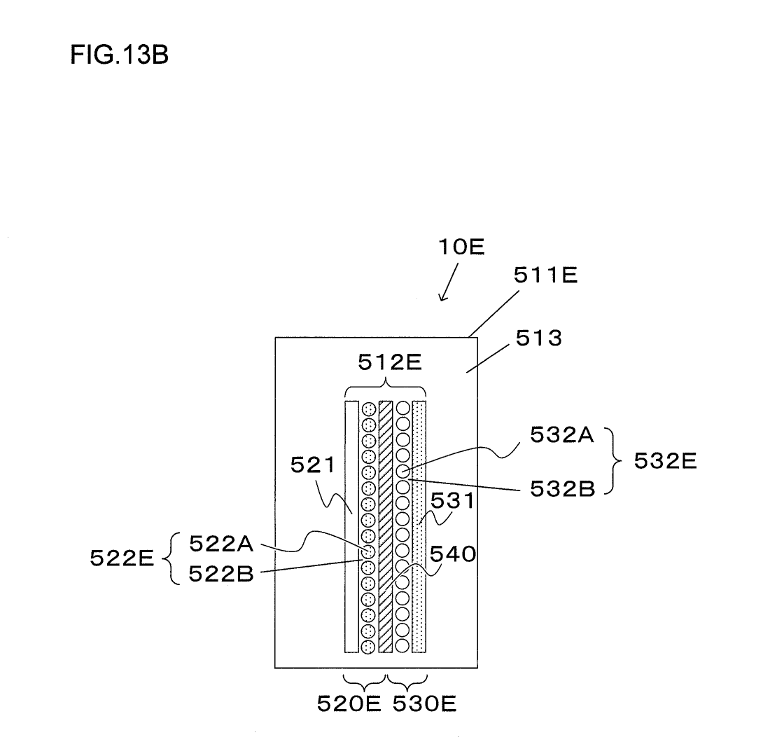

The cylindrical storage battery cell 10F having a larger diameter includes the electrode group 512F in the form of an elongate sheet as shown in FIG. 13A whereas the cylindrical storage battery cell 10E having a smaller diameter includes the electrode group 512E in the form of an elongate sheet as shown in FIG. 13B.

The electrode group 512F is fabricated by winding a positive electrode 520F and a negative electrode 530F together with a separator 540 that intervenes between the electrodes into a cylindrical shape. The electrode group 512E is fabricated by winding a positive electrode 520E and a negative electrode 530E together with a separator 540 that intervenes between the electrodes into a cylindrical shape. The positive electrode 520F and the negative electrode 530F include respective electrode layers 522F, 532F having constant thicknesses from the winding start edge to the winding end edge. The positive electrode 520E and the negative electrode 530E include respective electrode layers 522E, 532E having constant thicknesses from the winding start edge to the winding end edge. The electrode layers 522F, 532F of the storage battery cell 10F, each of which has a relatively large diameter, have respective thicknesses larger than the thicknesses of the electrode layers 522E, 532E of the storage battery cell 10E having a relatively small diameter. That is, the respective quotients of the positive electrode active material and the negative electrode active material in the electrolyte 513 are smaller in the electrode layers 522F, 532F than in the electrode layers 522E, 532E, so that the storage battery cell 10F having a relatively large diameter has a smaller amount of heat generation than the storage battery cell 10E having a relatively small diameter.

As explained above, the storage battery cells 10E, 10F have equal energy density and equal power density. According to this embodiment, the total lengths of the electrode groups 512E, 512F are determined so that the amounts of the active materials contained in the electrode layers 522F, 532F of the storage battery cell 10F are equal to the amounts of the active materials contained in the electrode layers 522E, 532E. As a result, the energy density and power density are the same for both the storage battery cells.

It is to be noted that FIGS. 13A and 13B are figures for schematically illustrating the electrode groups. Actually, a wound-type electrode group is fabricated as follows. That is, a positive electrode, which is constituted by current collector foil having been applied on both sides thereof a positive electrode active material, and a negative electrode, which is constituted by negative electrode current collector foil having been applied on both sides thereof a negative electrode active material, together with a separator that intervenes between the positive electrode and the negative electrode.

Control of the respective thicknesses of the positive electrode layers 522E, 522F and the negative electrode layers 532E, 532F is explained below. As mentioned above, the amount of heat generated by an electrode group can be controlled by increasing or decreasing the respective quotients of the active materials in the electrolyte. The amount of the electrolyte that is injected in the electrode layer depends on porosity of the electrode layer. The porosity of the electrode layer depends on the thickness of the electrode layer. The thickness of the electrode layer can be controlled by pressing it. Since the amount of the electrolyte to be injected in the electrode layer is in a proportional relationship to the thickness and porosity of the electrode layer, according to the present embodiment, the porosity of the electrode layer is controlled by pressing it in order to control the respective quotients of the active materials in the electrolyte and thus control the amount of heat generation.

Referring to the graph shown in FIG. 2, the quotients of the active materials in the electrolyte can be decreased from 50% to 20% by increasing the thicknesses of the electrode layers by 2.5 times. To increase the quotients of the active materials in the electrolyte from 50% to 80%, the respective thicknesses of the electrode layers may be decreased to around 0.6 times. Therefore, the horizontal axis in FIG. 2 can be said to be an index of relationship with the respective thicknesses of the positive electrode layer and the negative electrode layer.

As mentioned above, the thicknesses of the electrode layers 522E, 532E, 522F, 532F can be controlled by applying a mixture of the positive electrode active material or negative electrode active material, a binder and so on at both sides of the positive electrode metal foil 521 or the negative electrode metal foil 531, respectively, and then drying the metal foil 521, 531, and pressing it. With this control of the thicknesses, the amounts of heat generation in the laminated wound-type electrode groups 512E, 512F can be controlled.

Actually, if the quotients of the active materials in the electrolyte are set to be too small, there occur problems of loss of function of electrodes, such as hindrance of migration of electrons, peeling off of the active materials from the electrode foils. On the contrary, if the quotients of the active materials in the electrolyte are set to be too large, the ion conductivity becomes low, and equally, the function of the electrodes is lost. Accordingly, by implementation, besides that a conductive agent and a binder are used to secure conductivity of electrons and ions, the quotients of the active materials in the electrolyte must be determined taking into consideration a trade-off with the peeling off of the active materials from the electrode foils.

According to the sixth embodiment as explained above, the following effects can be obtained.

(1) It is commonly known that an assembled battery constituted by a plurality of storage battery cells (unit cells) may have non-uniform temperature distribution in the inside of each storage battery cell depending on the environment such as a variation of heat dissipation performance, presence or absence of an exothermic element and so on. Therefore, according to the sixth embodiment, a battery cell 10F that has a relatively large diameter and thus generates a relatively small amount of heat is arranged near a heat source HS that generates heat, whereas a battery cell 10E that has a relatively small diameter and thus generates a relatively large amount of heat is arranged remote from the heat source HS that generates heat. As a result, the plurality of storage battery cells 10E, 10F that constitute the assembled battery have decreased temperature distributions, respectively, so that the plurality of the storage battery cells 10E, 10F have equalized service lives, resulting in that the assembled battery in whole can enjoy a prolonged service life.

That is, a more generalized concept of the assembled battery according to the sixth embodiment may be explained as follows. An assembled battery is installed under an environment in which; a first storage battery cell group having small quotients of the active materials in the electrolyte is arranged closer to a first environment of high temperature, whereas a second storage battery cell group having larger quotients of the active materials in the electrolyte that are larger than the first storage battery cell group is arranged closer to a second environment of lower temperature than the first environment.

It is to be noted that in the sixth embodiment, explanation was made on the case of the assembled battery which is arranged near the heat source HS. It is conceivable that the temperature variation of the unit cells in the assembled battery is wide so that the degree of deterioration of the storage battery cells may differ from each other depending on the placement of storage battery cells within the assembled battery. Even in that case, if the storage battery cell 10F that generates a relatively small amount of heat is placed at a location where a temperature elevation is large within a space in which the assembled battery is installed, the variation in temperature distribution among the plurality of the storage battery cells can be decreased.

That is, the assembled battery as mentioned above can be constructed so that the first storage battery cell group in which the respective quotients of the positive active material and the negative active material in the electrolyte are relatively small are arranged in a first space in the housing where heat dissipation performance is relatively low, whereas the second storage battery cell group in which the respective quotients of the positive active material and the negative active material in the electrolyte are higher than the first storage battery cell group are arranged in a second space in the housing where heat dissipation performance is higher than in the first space.

(2) When controlling the amount of heat generation in the electrode group to be used in the storage battery cell according to the sixth embodiment, the amounts of the positive electrode active material and the negative electrode active material are substantially uniform regardless of the respective positions of the active materials on the current collector foil, so that there is no localization of the amounts of the positive active material and the negative active material. For this reason, there are observed substantially uniform structural changes of the positive active material and the negative active material that will develop upon transferring lithium ions in and out when a charge-discharge cycle is repeated. As a result, an effect of decreasing local deterioration of the storage battery cells, so that the assembled battery in whole can enjoy a prolonged service life.

### Seventh Embodiment

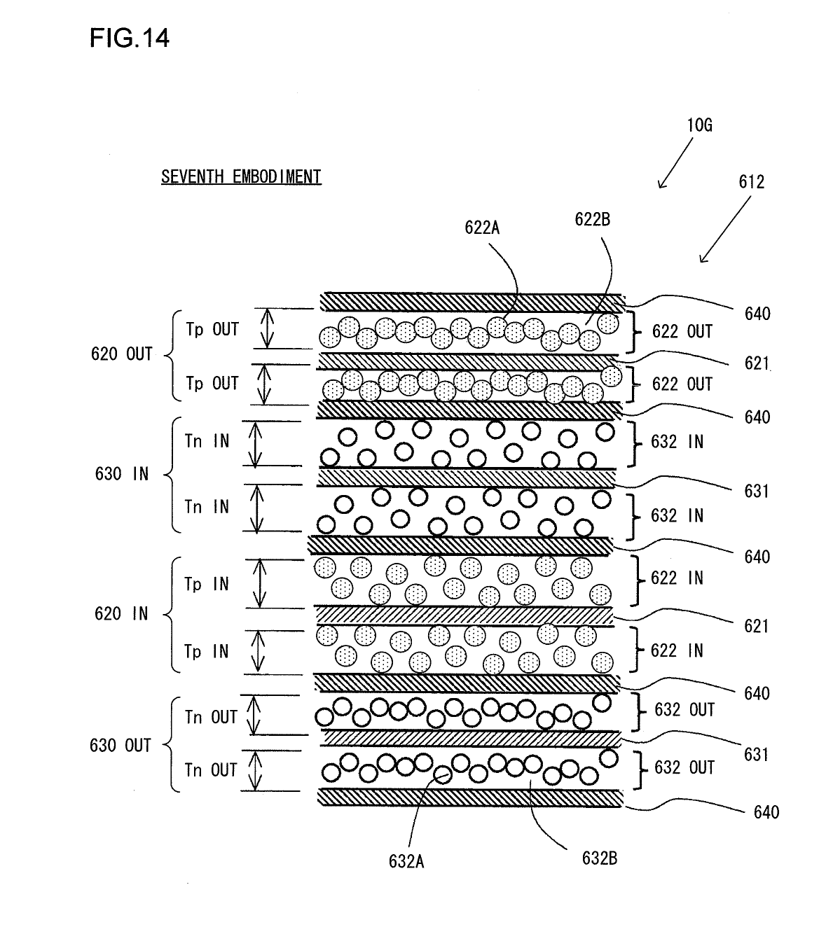

A storage battery cell according to a seventh embodiment of the present invention is explained with reference to FIG. 14. It is to be noted that in the figure, parts that are the same as or corresponding to parts of the first embodiment are assigned with numerals in the 600s and explanation is made concentrating on differences between the first and seventh embodiments.

According to the seventh embodiment, the present invention is applied to a laminated-type storage battery cell having a plurality of electrode layers.

As mentioned above, the electrode group has inferior heat dissipation performance in the central portion (inside the battery cell) than on the surface of the storage battery cell. The storage battery cell according to the seventh embodiment is a laminated-type storage battery cell fabricated by laminating a positive electrode and a negative electrode, each of which is in the form of rectangular sheet. In this embodiment, the electrode layers in the inside of the battery cell is made relatively thick and the electrode layers on the surface side of the battery cell is made relatively thin in order to make uniform the temperature distribution in the battery cell.

FIG. 14 shows an example of an electrode group 612 which is constituted by a positive electrode 620in and a negative electrode 630in, which have relatively large thicknesses and are arranged in the deepest portion (central portion) of the battery cell and a positive electrode 620out and a negative electrode 630out, which have relatively small thicknesses and are arranged on the surface side of the battery cell. A separator 640 is provided so as to intervene between the positive electrode 620out on the front side and the negative electrode 630in on the inner side, whereas a separator 640 is provided between the negative electrode 630out on the rear side and the positive electrode 620in on the inner side.

The positive electrode layer 622out arranged on the front side and the negative electrode layer 632out on the rear side have respective thicknesses Tpout, Tnout of the positive electrode are set smaller than respective thicknesses Tpin, Tnin of the positive electrode layer 622in and the negative electrode layer 632in that are arranged on the center side, so that the positive electrode layer 622in and the negative electrode 632in that are arranged inner generate suppressed amounts of heat. With this configuration, the positive electrode layer 622in and the negative electrode layer 632in, which are arranged inner side where heat dissipation performance is low, generate smaller amounts of heat than the positive electrode layer 622out and the negative electrode layer 632out, which are arranged on the outer side of the electrode group 612, so that the electrode group 612 in whole exhibits a uniform increase in temperature.

### Eighth Embodiment

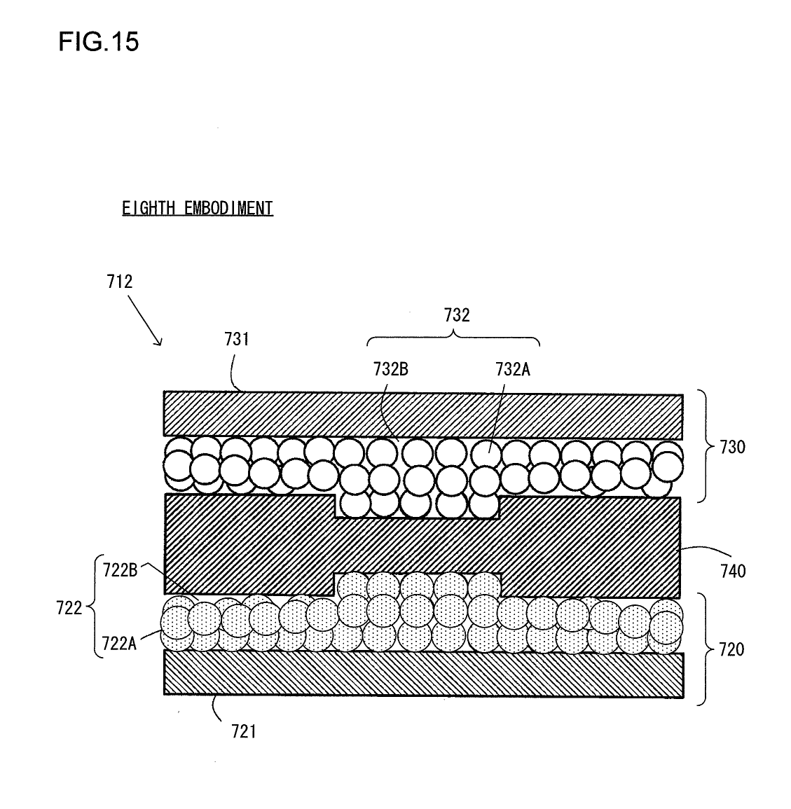

A storage battery cell according to an eighth embodiment of the present invention is explained with reference to FIG. 15. It is to be noted that in the figure, parts that are the same as or corresponding to parts of the first embodiment are assigned with numerals in the 700s and explanation is made concentrating on differences between the first and eighth embodiments. The eighth embodiment relates to an example of an electrode group exhibiting effects that are equivalent to those of the electrode layer 22 according to the first embodiment. More particularly, the electrode group according to the eighth embodiment has a thickness of the electrode layer along the width direction thereof, which is non-smoothly varied stepwise.

An electrode group 712 according to the eighth embodiment is constructed by laminating a positive electrode 720 and a negative electrode 730 together with a separator 740 that intervenes between the electrodes 720, 730. The positive electrode 720 includes positive electrode metal foil 721 in the form of a plate and a positive electrode layer 722 applied on one surface of the positive electrode metal foil 721. The negative electrode 730 includes negative electrode metal foil 731 and a negative electrode layer 732 applied on one surface of the negative electrode metal foil 731. A separator 740 having a reduced thickness in the center is provided between the positive electrode layer 722 and the negative electrode layer 732. The positive electrode layer 722 and the negative electrode layer 732 have larger thicknesses, respectively, in a region where the thickness of the central portion of the separator 740 is smaller than elsewhere. In other words, the electrode layers 720, 730 according to the eighth embodiment are formed stepwise. As explained above, since the smaller the respective quotients of the active materials 722A, 732A in the electrolyte are, the smaller the amount of heat generations in the electrodes are, heat generation in the storage battery according to the eighth embodiment is suppressed in the inside (deepest portion) of the battery cell. As a result, the battery cell in whole has a decreased temperature distribution.

### Variation Example

According to the first embodiment, the thickness of the separator 40 is made non-uniform to make uniform the thickness of the electrode group 12. However, if non-uniformity in the thickness of the electrode group 12 is acceptable, the thickness of the separator 40 may be made uniform. Alternatively, the thickness of the electrode group 12 may be made uniform by making the thickness of the separator 40 uniform while making non-uniform the respective thicknesses of the positive electrode current collector foil 21 and the negative electrode current collector foil 31 corresponding to respective variations in the thicknesses of the positive electrode layer 22 and the negative electrode layer 32.

In the above-mentioned embodiments, the particle sizes of the positive electrode active material and the negative electrode active material are made uniform, respectively. However, the particle sizes may be varied depending on the respective positions of the particles of the active materials on the positive electrode current collector foil 21 and the negative electrode current collector foil 3 to adjust the thicknesses of the positive electrode layer 122 and the negative electrode layer 132, respectively, depending on the particle sizes of the active materials. In the portion of the electrode group where the positive electrode active material 122A and the negative electrode active material 132A have relatively large particle sizes, respectively, the porosity of the electrode layers increase, so that the amount of heat generation at that portion is suppressed.

The above described embodiments are exemplary and various modifications can be made without departing from the scope of the invention.

What is claimed is:

1. A storage battery cell comprising:
an electrode group in which a positive electrode including positive electrode current collector foil provided with a positive electrode layer containing a positive electrode active material, a negative electrode including negative electrode current collector foil provided with a negative electrode layer containing a negative electrode active material, and a separator that intervenes between the positive electrode and the negative electrode are laminated;
a battery cell container that houses the electrode group; and
an electrolyte injected in the battery cell container, wherein:
the positive electrode active material and the negative electrode active material substantially uniformly distribute in the positive electrode layer and the negative electrode layer, respectively, and
the positive electrode layer and the negative electrode layer in which the positive electrode active material and the negative electrode active material, respectively, distribute substantially uniformly, are provided respectively with regions in which respective quotients of the positive active material and the negative active material in the electrolyte are varied.

2. A storage battery cell according to claim 1, wherein:
the respective quotients of the positive electrode active material and the negative electrode active material in the electrolyte are controlled depending on respective thicknesses of the positive electrode layer and the negative electrode layer, and
each of the positive electrode layer and the negative electrode layer has regions where the respective thicknesses of the positive electrode layer and the negative electrode layer are varied in a plane of the electrode group.

3. A storage battery cell according to claim 2, wherein
the electrode group is a laminate-type electrode group in which a positive electrode, a negative electrode and a separator, which respectively are shaped as rectangular sheets, are laminated, and
the respective thicknesses of the positive electrode layer and the negative electrode layer, in a plane in which the electrode shaped as rectangular sheet extends, are larger in central portions than in peripheral portions.

4. A storage battery cell according to claim 2, wherein
the thicknesses of the positive electrode layer and the negative electrode layer are smoothly varied along width direction.

5. A storage battery cell according to claim 2, wherein
the thicknesses of the positive electrode layer and the negative electrode layer are varied non-smoothly along width direction.

6. A storage battery cell according to claim 1, wherein
the electrode group is a wound-type electrode group in which a positive electrode, a negative electrode and a separator, which respectively are shaped as elongate sheets, are wound around, and
a thickness of the electrode layer at a winding start edge is larger than a thickness of the electrode layer at a winding end edge.

7. A storage battery cell according to claim 6, wherein
the thickness of the electrode layer is gradually increased, along a longitudinal direction of the electrode group that is shaped as elongate sheet, from the winding start edge toward the winding end edge.

8. A storage battery cell according to claim 1, wherein
the electrode group is a wound-type electrode group in which a positive electrode, a negative electrode and a separator, which respectively are shaped as elongate sheets, and
a thickness of the electrode layer, in central portion along a width direction of the electrode group that is shaped as elongate sheet, is larger than thicknesses of both edges along the width direction of the electrode group.

9. A storage battery cell according to claim 2, wherein
a thickness profile of the separator is complementary to thickness profiles of the positive electrode layer and the negative electrode layer, and
the electrode group has a thickness that is constant over an entire region thereof.

10. A storage battery cell according to claim 1, wherein
the quotients of the positive electrode active material and the negative electrode active material in the electrolyte are controlled depending on respective porosities of the positive electrode layer and the negative electrode layer, and
the positive electrode layer and the negative electrode layer have respective regions where the porosities are different from each other in a plane of the electrode group.

11. An assembled battery, comprising: a plurality of storage battery cells according to claim 1;
a bus bar that connects the plurality of storage battery cells in series or in series-parallel; and
a housing in which the plurality of the storage battery cells are housed, wherein
the plurality of the storage battery cells include a first storage battery cell group consisting of a plurality of storage battery cells having small quotients of the positive electrode active material and the negative electrode active material in the electrolyte, and a second storage battery cell group consisting of a plurality of storage battery cells having larger quotients of the positive electrode active material and the negative electrode active material in the electrolyte than the first storage battery cell group.

12. An assembled battery setup method for setting up an assembled battery according to claim 11, wherein
the assembled battery is installed under an environment in which; the first storage battery cell group having small quotients of the positive electrode active material and the negative electrode active material in the electrolyte are arranged close to a first environment of high temperature, whereas the second storage battery cell group having larger quotients of the positive electrode active material and the negative electrode active material in the electrolyte than the first storage battery cell group are arranged close to a second environment of lower temperature than the first environment.

13. An assembled battery according to claim 11, wherein
the first storage battery cell group having small quotients of the positive electrode active material and the negative electrode active material in the electrolyte is arranged in a first space in the housing, in which heat dissipation performance is low, and
the second storage battery cell group having larger quotients of the positive electrode active material and the negative electrode active material in the electrolyte than the first storage battery cell group is arranged in a second space in the housing, in which heat dissipation performance is higher than the first space.

14. An electrode group for a secondary battery cell, immersed in an electrolyte in a battery cell container, in which a positive electrode including positive electrode current collector foil and a positive electrode layer that contains a positive electrode active material and is provided on the positive electrode current collector foil, a negative electrode including negative electrode current collector foil and a negative electrode layer that contains a negative electrode active material and is provided on negative electrode current collector foil, and a separator that intervenes between the positive electrode and the negative electrode are laminated, wherein
the positive electrode active material and the negative electrode active material uniformly distribute in the positive electrode layer and the negative electrode layer, respectively, and
the positive electrode layer and the negative electrode layer, in which respectively the positive electrode active material and the negative electrode active material distribute uniformly, are respectively provided with regions where respective quotients of the positive electrode active material and the negative electrode active material in the electrolyte are varied.

15. An electrode group for a secondary battery cell according to claim 14, wherein
the respective quotients of the positive electrode active material and the negative electrode active material in the electrolyte are controlled depending on respective thicknesses of the positive electrode layer and the negative electrode layer, and
the positive electrode layer and the negative electrode layer have respective regions in a plane of the electrode group, in which respective thicknesses of the positive electrode layer and the negative electrode layer are varied.

16. An electrode group for a secondary battery cell according to claim 14, wherein
the respective quotients of the positive electrode active material and the negative electrode active material in the electrolyte are controlled depending on porosities of the positive electrode layer and the negative electrode layer, and
the positive electrode layer and the negative electrode layer have regions in a plane of the electrode group, in which respective porosities are varied.

17. A production method of electrode group for secondary battery cell, for producing an electrode group for a secondary battery cell according to claim 14, comprising:
a step of applying a positive electrode active material and a negative electrode active material on positive electrode current collector foil and negative electrode current collector foil, respectively, so that the positive electrode active material and the negative electrode active material uniformly distribute on positive electrode current collector foil and negative electrode current collector foil, respectively;
a step of drying the positive electrode active material and the negative electrode active material applied on the positive electrode current collector foil and the negative electrode current collector foil, respectively; and
a step of pressing respectively the positive electrode active material and the negative electrode active layer on the positive electrode current collector foil and the negative electrode current collector foil, after the step of drying, to fabricate a positive electrode layer and a negative electrode layer, so that the regions in which the respective porosities are varied.

18. A production method of electrode group for secondary battery cell according to claim 17, wherein
in the step of pressing, the respective porosities of the region of the positive electrode layer and the negative electrode layer are controlled by controlling amounts of press against the positive electrode active material and the negative electrode active material, respectively.

19. A production method of electrode group for secondary battery cell, for producing an electrode group for a secondary battery cell according to claim 14, comprising:
a step of applying a positive electrode active material and a negative electrode active material onto positive electrode current collector foil and negative electrode current collector foil, respectively, so that the positive electrode active material and the negative electrode active material uniformly distribute in the electrode layers,
a step of drying the positive electrode active material and the negative electrode active material applied to the positive electrode current collector foil and the negative electrode current collector foil, respectively;
a step of cutting respectively the positive electrode current collector foil and the negative electrode current collector foil on which the positive electrode active material and the negative electrode active material, after the step of drying, are applied to predetermined lengths to form a positive electrode and a negative electrode, respectively;
a step of winding the positive electrode and the negative electrode together with a separator that intervenes between the electrodes at a predetermined tensional force, wherein
in the step of winding, the predetermined tensional force is controlled so that the regions in which the porosities are varied are formed.
